(19) United States
(12) Patent Application Publication
(10) Pub. No.: US 2011/0026374 A1
(43) Pub. Date: Feb. 3, 2011

(54) Programmable watch winding apparatus

(76) Inventor: Shih-Tsung Chang, Taichung City (TW)

Correspondence Address: CHARLES E. BAXLEY, ESQUIRE, 90 JOHN STREET, SUITE 403, NEW YORK, NY, 10038, US

(21) Appl. No.: 12/462,313

(22) Filed: Jul. 31, 2009

(51) Int. Cl. G04B 5/00

(52) U.S. Cl. 368/206

(57) ABSTRACT

A programmable watch winding apparatus includes a user interface for users to input a winding number and rotational direction of turns the programmable watch winding apparatus performs to wind a mechanical watch, and a control unit controlling a transmission device to rotate a rotatory base according to the users' input. Thereby, the programmable watch winding apparatus is fully controlled to automatically wind the mechanical watch carried thereon.

### BACKGROUND OF THE INVENTION

1. Technical Field

The present invention relates to a watch winding apparatuses for automatically winding mechanical watches. More particularly, the present invention relates to a programmable watch winding apparatus that autumnally winds mechanical watches in a fully controlled manner.

2. Description of Related Art

A watch winding apparatus is designed for automatically winding mechanical watches. Mechanical watches are wound by kinetic energy created from human hands' movement. Watch winding apparatuses have thus been developed for performing particular operation to substitute for human hands and keep mechanical watched wound during periods of non-use.

A known orbital watch-winding apparatus is disclosed in U.S. Pat. No. 6,254,270. The orbital watch-winding apparatus includes a base unit and a mandrel rotatably mounted to the base unit. A watch is supported on the outer surface of the mandrel. When activated, the watch moves in a circular path. The orbital motion of the watch causes the self-winding mechanism to swing back and forth to simulate the effect produced by normal arm movements when the watch is worn by a user.

The known orbital watch-winding apparatus operates in a time-based manner. For example, it may be set to operate for a time period, such as 20 or 30 minutes, so as to continuously wind a watch carried thereon during the time period. However, the rotational rate of a motor in the orbital watch-winding apparatus may be subject to the changeable supply voltage and unlikely to remain constant. Consequently, the number of turns performed by the orbital watch-winding apparatus during a preset time period cannot be accurately controlled and thus the watch may be over-wound or under-wound.

Besides, operational vibration of the orbital watch-winding apparatus may damage the apparatus itself or the watch thereon. In addition, the mechanism may be damaged when the mandrel receives an outward force counter to its rotational direction or an additional co-rotating force excessively accelerating rotation of the mandrel. However, the prior art provides no approach to addressing the problems.

### SUMMARY OF THE INVENTION

One objective of the present invention is to provide a programmable watch winding apparatus that winds a mechanical watch by rotating the mechanical watch in a predetermined direction by a predetermined number of turns, and prevents the mechanical watch from over-winding or under-winding.

Another objective of the present invention is to provide a programmable watch winding apparatus that buffs mechanical resonance so as to operate with less operational noise and protect a mechanical watch carried thereon from vibration-induced damage.

Another objective of the present invention is to provide a programmable watch winding apparatus that is equipped with cushion components for protecting reduction gears in a transmission device thereof from being damaged when imposed with an outward reverse force or an additional co-rotating force excessively accelerating rotation thereof.

Another objective of the present invention is to provide a programmable watch winding apparatus that implements a control unit to control a number of winding turns and stop operating when a predetermined number is reached so as to ensure the mechanical watch wound sufficiently and eliminate over-winding and under-winding.

The programmable watch winding apparatus of the present invention includes a user interface that allows a user to operate and input a rotational direction and a number of winding turns. The programmable watch winding apparatus also includes a control unit that drives the transmission device of the programmable watch winding apparatus to rotate a rotatory base for the preset number of winding turns.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a perspective view of a programmable watch winding apparatus of the present invention;

FIG. 2 is a schematic view of the programmable watch winding apparatus of the present invention;

FIG. 3 is an exploded view of a transmission device of the programmable watch winding apparatus of the present invention;

FIG. 4 is an assembled view of the transmission device of the programmable watch winding apparatus of the present invention;

FIG. 5 is a block diagram showing a control module of the programmable watch winding apparatus of the present invention;

FIG. 6 is a schematic drawing of a user interface according to the present invention; and

FIGS. 7 and 8 are applied views of the user interface according to the present invention.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

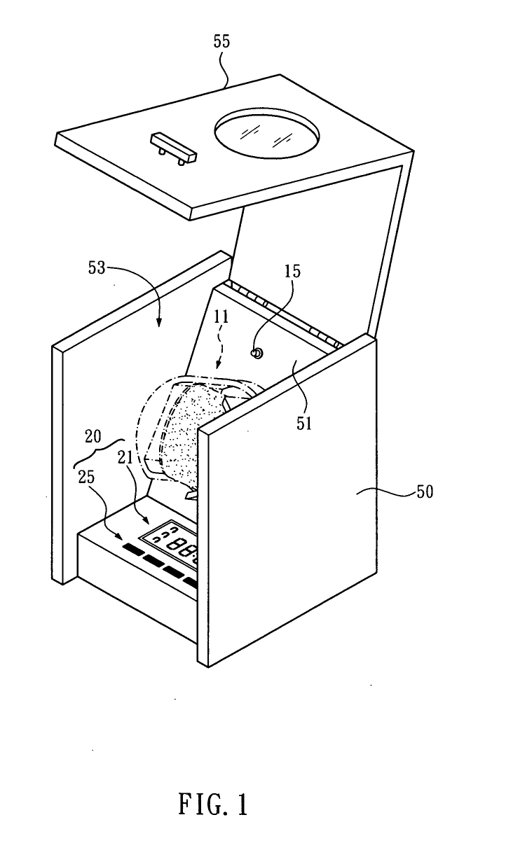

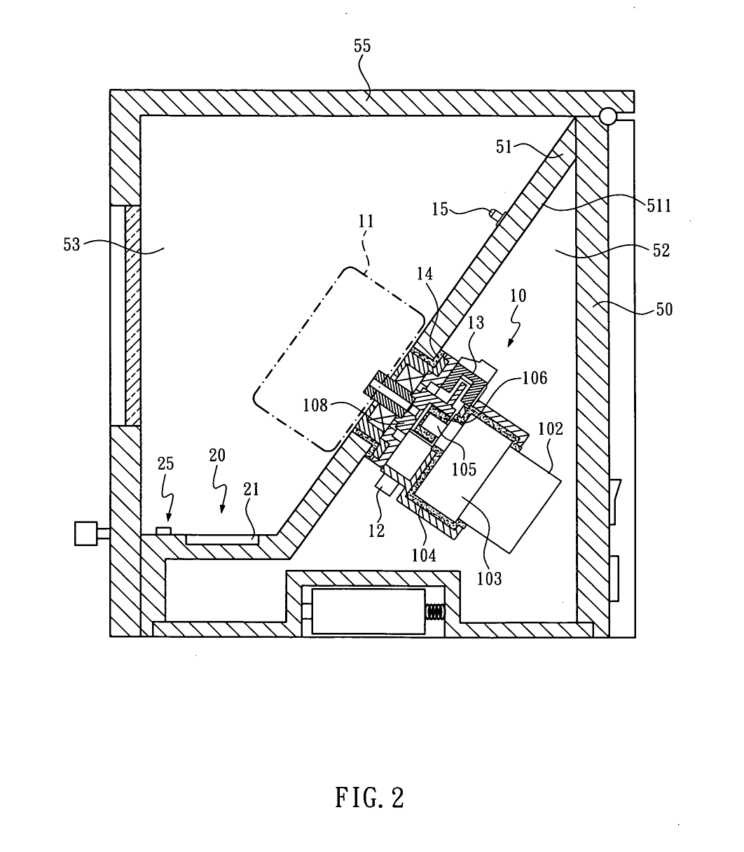

Please refer to FIGS. 1 and 2 for a programmable watch winding apparatus of the present invention. The programmable watch winding apparatus includes a box 50, a gear motor 10, a rotatory base 11, a sensor 12, a user interface 20, and a control unit 30.

The box 50 has an inclined partition 51 that separates the box 50 into an inward part 52 and an outward part 53. The box 50 is provided with a liftable cover 55 that serves to close the outward part 53 when affixed to the box 50.

The transmission device 10 is fixed to an inner surface 511 of the partition 51 and positioned in the inward part 52. A driving shaft 101 of the transmission device 10 pierces through the partition 51 and becomes exposes in the outward part 53.

The rotatory base 11 is connected with the driving shaft 101 of the transmission device 10 and positioned in the inward part 52 so that a mechanical watch (not shown) can be mounted therearound.

The sensor 12 is provided about the transmission device 10 for sensing the turns of the driving shaft 105 of the transmission device 10. The sensor 12 may be realized by any known optical encoder.

The user interface 20 includes a display unit 21 and an input unit 25 that are provided at a surface of the box 50 for users to easily view and operate the same.

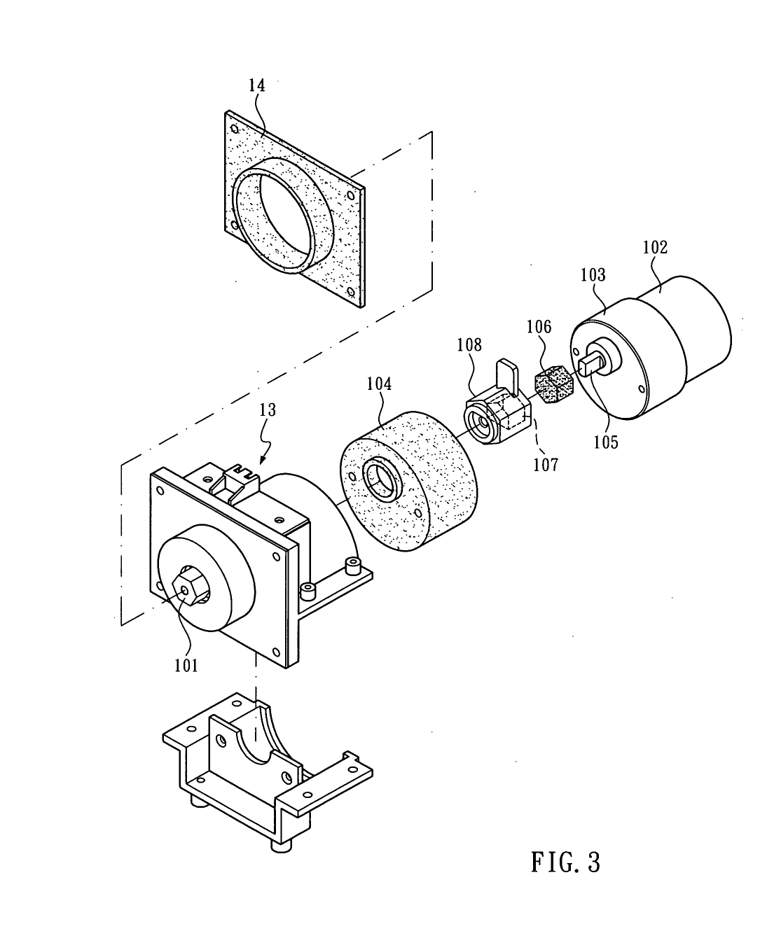

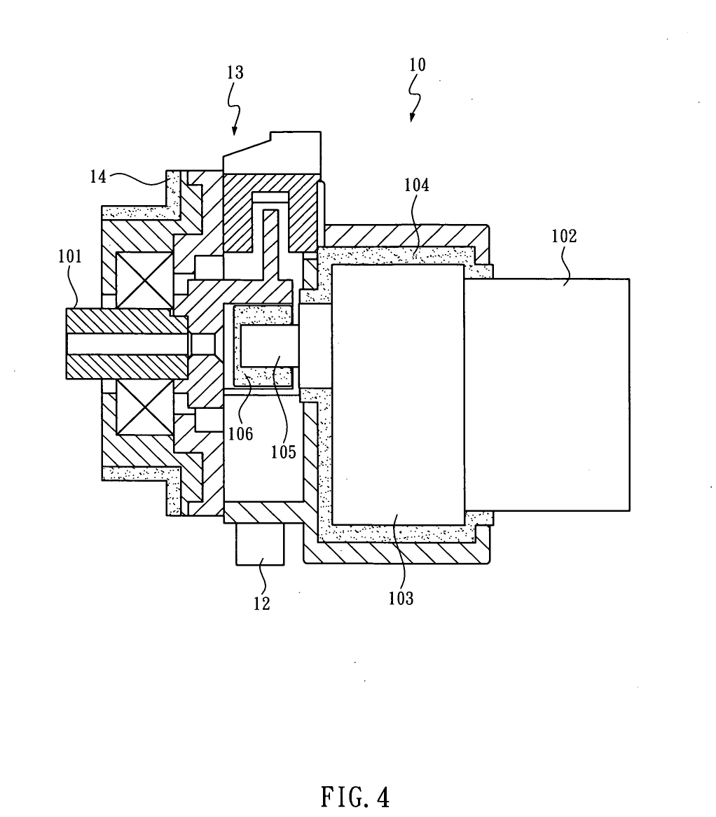

Referring to FIGS. 3 and 4, the transmission device 10 is fixed to the partition 51 by a seat 13. A cushion pad 14 is provided at a border between the seat 13 and the partition 51 for buffing impact and reducing the vibration the transmission device 10 imparts to the partition 51 when the transmission device 10 is actuated. As a result, the entire box 50 performs less resonance while the operational noise of the programmable watch winding apparatus is also reduced. Meantime, since the vibration the transmission device 10 imparts to the partition 51 is reduced, the programmable watch winding apparatus is unlikely to damage watches.

In the transmission device 10, the driving shaft 101 is rotated in a predetermined rotation rate by a motor 102 through a reduction gear box 103 so as to drive the rotatory base 11 connected thereto. A flexible sleeve 104 is mounted around the reduction gear box 103. The flexible sleeve 104 is positioned inside the seat 13 and abutting against an inner wall of the seat 13. An output shaft 105 of the reduction gear box 103 is shielded by a flexible axis guide 106. The flexible axis guide 106 has a polygonal shape for mating a polygonal hole 107 formed in a coupler 108 of the driving shaft 101 and abutting against an inner wall of the coupler 108. The sleeve 104 services for buffer and shock absorption, so as to protect the precise gears in the reduction gear box 103 from being affected by operational vibration of the motor 102 or the rotatory base 11. The axis guide 106 ensures close combination between the output shaft 105 and the driving shaft 101 so as to eliminate the problem related to idle running of the output shaft 105 and ensure that the rotatory base 11 connected with the driving shaft 101 performs predetermined terms. However, when the rotatory base 11 is rotated by an outward force reverse to or along with the rotational direction of the output shaft 105, the driving shaft 101 has the coupler 108 rotating about the axis guide 106 under a resistance. Thus, the undesired outward force is blocked from reaching the output shaft 105, so as to protect the precise gears in the reduction gear box 103.

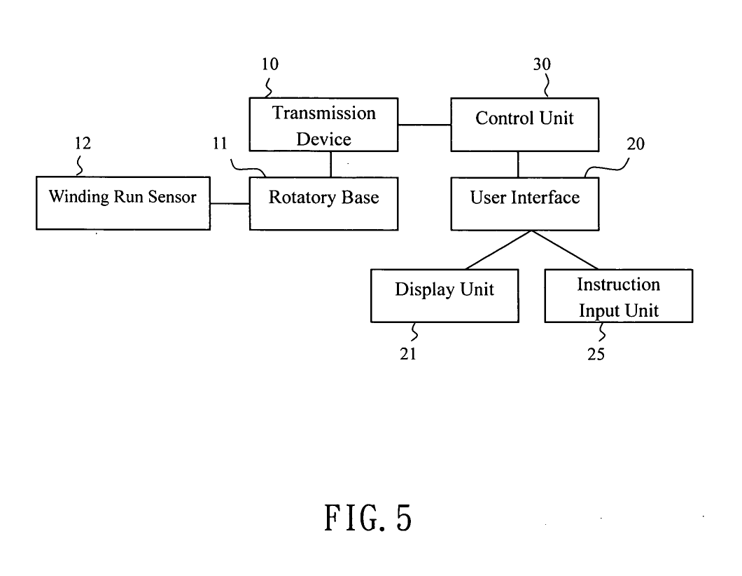

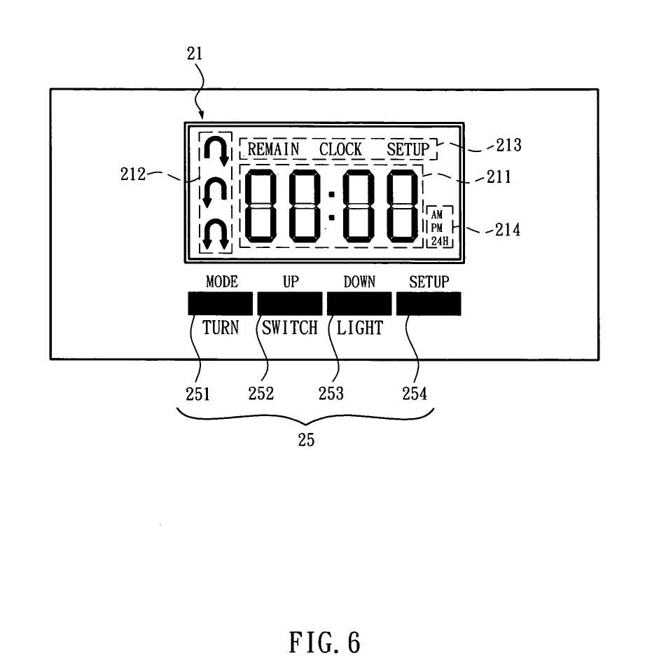

FIGS. 5 and 6 illustrate the user interface 20. The display unit 21 of the user interface 20 displays information related to the performed turns of the rotatory base 11 or remained turns to be performed by the rotatory base 11, and the rotational direction. The turns are displayed in numerical forms while the rotational direction is shown by figurative symbols. The input unit 25 includes a plurality of buttons for users to operate and thus input instructions related to the turns and directions.

The control unit 30 is coupled with the user interface 20 and the transmission device 10 for receiving and processing the instructions input from the input unit 25, controlling the driving shaft 101 of the transmission device 10 to rotate in a predetermined direction, receiving and processing signals related to turns output by the sensor 12, and stopping the transmission device 10 when the rotatory base 11 has performed a particular number of turns. The control unit 30 also exhibits the turns input by users, performed turns, and turns to be performed at the display unit 21.

The display unit 21 is an LCD screen that includes a main display area 211, a direction display area 212, an instruction area 213 and a time area 214.

The main display area 211 acts as an electronic clock telling the current time in an “hour: minute” format or shows the performed turns (or turns to be performed). For example, 23:10 indicates that the current time is ten minutes after eleven o'clock. In another example, 25:00 means the turns for the rotatory base 11 to perform is 25 turns.

The direction display area 212 uses figurative symbols to describe the present rotational direction.

The instruction area 213 displays phrases of relevant instructions, such as REMAIN (turns to be performed), CLOCK (clock), and SETUP (setting). For example, when it is the current time shown in the main area 211, the instruction area 213 presents the phrase “CLOCK”. When it is the turns to be performed shown in the main area 211, the instruction area 213 presents the phrase “REMAIN”. When a setup button 254 is pressed, the instruction area 213 presents “SETUP”.

The time area 214 shows time in the format of AM, PM or 24H.

The input unit 25 comprises a turn button 251, a switch button 252, a light button 253, and the previously mentioned setup button 254.

The turn button 251 is associated with actuation of the transmission device 10.

The switch button 252 is used to control the main display area 211 to present the remained turns or the current time.

The light button 253 can be operated to turn on or off a light 15 for illuminating the outward part 53 of the box 50.

After the setup button 254 is pressed, the turn button 251 turns to serve for mode selection and the switch button 252 turns to serve for adding numbers “UP” while the light button 253 turns to serve for reducing numbers “DOWN”. At this time, upon pressing the turn button 251 the hour, minute, time format (AM/PM/24 hours), right turns, and left turns can be successively set by adding or reducing numbers with the “UP” or “DOWN” buttons 252, 253.

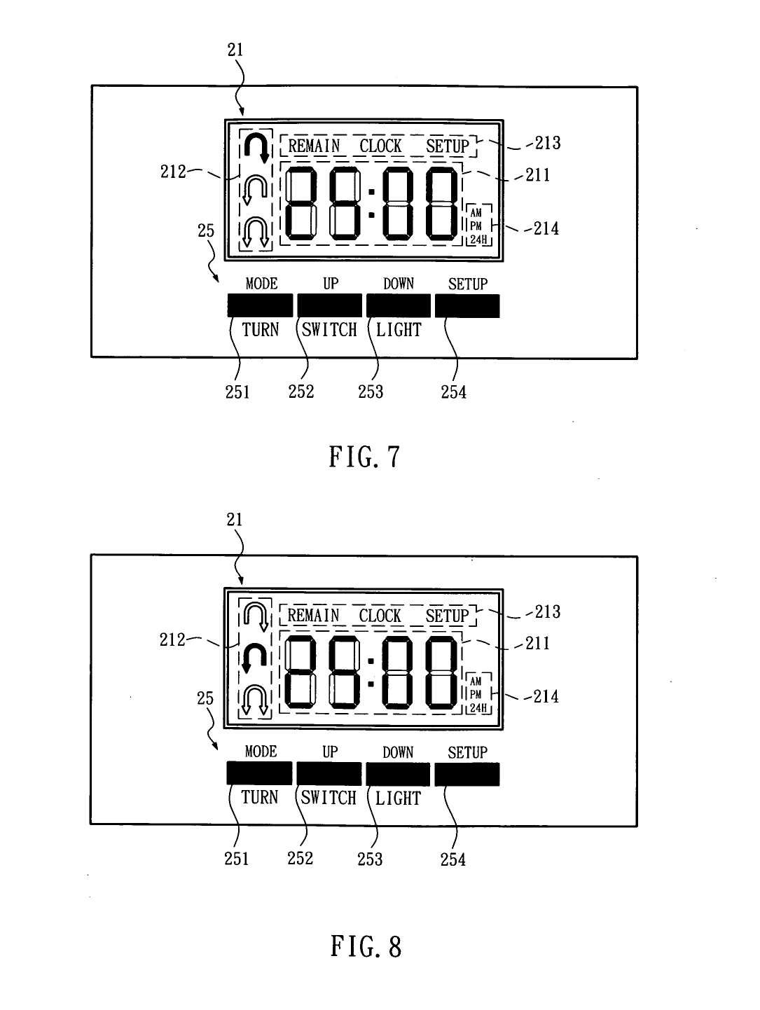

As shown in FIG. 7, when the turn button 251 is pressed for the first time, the right turn symbol in the direction area 212 is lighted up and the main display area 211 presents the phrase of “REMAIN”. Afterward, the transmission device 10 starts to rotate right, while the sensor 12 detecting the turns the rotatory base 11 performs. The number of “REMAIN” counted down with the additional turns the rotatory base 11 performs, until the number becomes zero and the programmable watch winding apparatus stops. In this manner, the programmable watch winding apparatus operates every 30 minutes, namely 48 times a day.

Referring to FIG. 8, when the turn button 251 is pressed for the second time, the left turn symbol in the direction area 212 is lighted up and the transmission device 10 starts to rotate left while the operation of the sensor 12 and display are similar to those described in the above paragraph.

When the turn button 251 is pressed for the third time, the dual-direction turn symbol in the direction area 212 is lighted up and the transmission device 10 starts to rotate right for the preset turns and at the next 30-minute points starts to rotate left for the preset turns.

The known winding device operates on a time-counting base. For example, the motor operates continuously for 20 or 30 minutes. However, during the continuous operation period, the number of turns is uncontrollable and tends to vary with the changing rotation speed caused by the voltage difference. As the present invention differently operates upon winding turns, the number of turns can be perfectly controlled and thus the problem related to insufficient or over winding can be eliminated.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A programmable watch winding apparatus, comprising:
a box having a partition that separates the box into an inward part and an outward part;
a transmission device fixed to the partition and received in the inward part, a driving shaft of the transmission device piercing through the partition;
a rotatory base connected with the driving shaft of the transmission device and exposed in the outward part of the box;
a sensor settled in the box for sensing turns of the rotatory base;
a user interface including a display unit and an input unit that are provided at an external surface of the box; and
a control unit coupled with the user interface, the display unit, the sensor and the transmission device for controlling actuation, stop, rotational directions, and a number of turns of the transmission device.

2. The programmable watch winding apparatus of claim 1, wherein the input unit includes a plurality of buttons at the surface of the box.

3. The programmable watch winding apparatus of claim 1, wherein the box comprises a light for illuminating the outward part.

4. The programmable watch winding apparatus of claim 1, wherein the display unit is an LCD screen that includes a main display area for presenting a current time or number of turns the rotatory base performs, and a direction display area for showing a rotational direction of the rotatory base.

5. The programmable watch winding apparatus of claim 1, wherein the transmission device is fixed to the partition by a seat and a cushion pad is provided at a border between the seat and the partition.

6. The programmable watch winding apparatus of claim 5, wherein the transmission device includes a motor and a reduction gear box, the reduction gear box having an output shaft shielded by a flexible axis guide, the flexible axis guide having a polygonal shape for mating a polygonal hole formed on the driving shaft and abutting against an inner wall of the driving shaft.

7. The programmable watch winding apparatus of claim 6, wherein a flexible sleeve is mounted around the reduction gear box, the flexible sleeve being positioned inside the seat and abutting against an inner wall of the seat.
